(19) United States
(12) Patent Application Publication
(10) Pub. No.: US 2003/0159545 A1
(43) Pub. Date: Aug. 28, 2003

(54) Crown cork opener

(76) Inventor: Bruno Teppe, Viriat (FR)

Correspondence Address: GREENBLUM & BERNSTEIN, P.L.C., 1950 ROLAND CLARKE PLACE, RESTON, VA, 20191, US

(21) Appl. No.: 10/276,296

(22) PCT Filed: Apr. 13, 2001
(86) PCT No.: PCT/FR01/01142

(51) Int. Cl. B67B 7/00

(52) U.S. Cl. 81/3.07; 81/3.55

(57) ABSTRACT

The invention concerns a crown cork opener (2) consisting of a handle (4) associated with a bottle opening head (3) comprising a central cut with a support element (17) of a catching member (19) on its edge, the support element being located between the handle (4) and the catching member (19), a device designed to be fixed (1) on the first forefinger and middle finger bone being attached on the handle (4), said fixing device (1) enabling to hold the bottle opener in hand constantly without inconvenience and to open bottles single-handed.

The invention relates to a device for fixing a crown cork opener onto the fingers of the hand.

Crown corks are intended to stopper the necks of bottles, the rims of which have a retainer of semi-toric shape or a screw thread having at least one undercut; crown corks consist mainly of a metal disk placed on the neck concentric therewith, the edges of which are knocked down laterally to crimp it onto the retainer, forming a crinkle band. A great many crown cork openers exist; these generally comprise a handle extended by an opening head comprising two devices; a device via which the opening head bears on the upper part of the cap and a device for catching under at least one crinkle of the crinkle band; when the bottle opener is in position on the crown cork, opening is achieved either by raising the handle if the catching device is situated between the handle and the bearing device, or by lowering the handle if the bearing device is between the handle and the catching device.

Patent FR-A-2,707,278 describes a bottle opener additionally comprising a device for fitting the latter onto a finger of the hand; this adapter device forms, with the opening head, a ring which, when slipped onto a finger, allows the bottle opener to be secured to the hand; under these conditions, the handle of the bottle opener lies in the palm of the hand and bottle opening is achieved by leaning on the handle with the palm of the hand; this adapter device is connected to the bottle opener in a region lying between the bearing device and the catching device which lie at the level of the first finger bone in the region where the finger bones are well differentiated; a device such as this has the disadvantage of being relatively bulky and of hampering the user in his other activities such as, for example, handling coins or shaking hands with someone else; what happens is that the additional thickness of the opening head situated under the finger bone and the handle prevent certain objects from being grasped correctly.

The invention consists in producing a bottle opener fixed to the fingers of the hand by a fixing device in such a way that serving staff using a tray to serve a round of drinks indoors or out can open the bottles with just one hand, without having beforehand to reach into a pocket for the bottle opener, and then carry out all the other operations involved in the function without being significantly hampered by the bottle opener which remains in place on his or her hand.

In the appended drawings:

FIG. 1 is a view in elevation of the bottle opener in question.

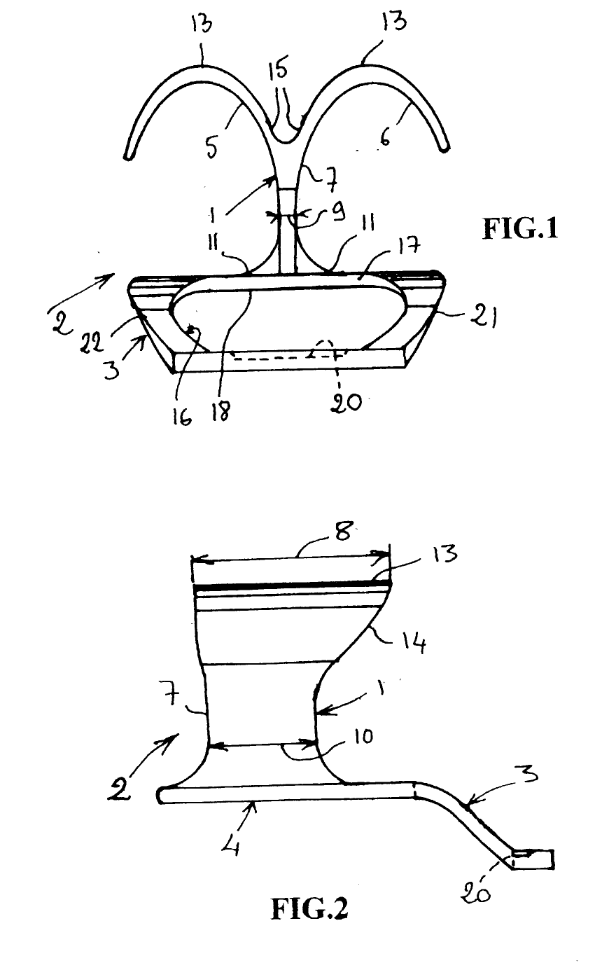

FIG. 2 is a side view thereof.

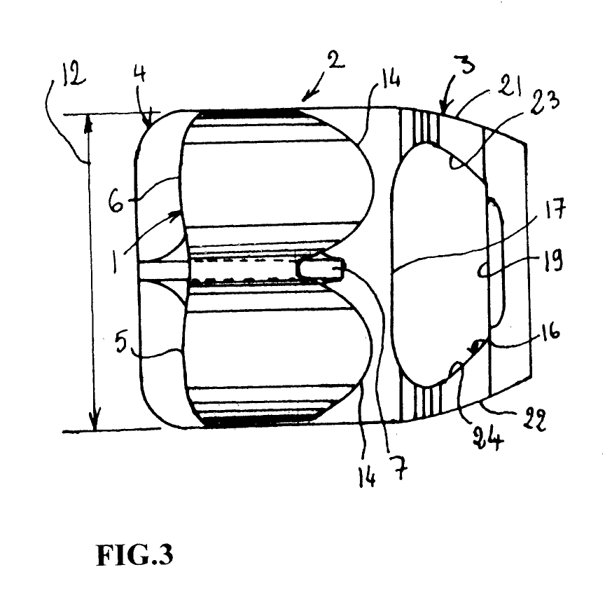

FIG. 3 is a plan view thereof from above.

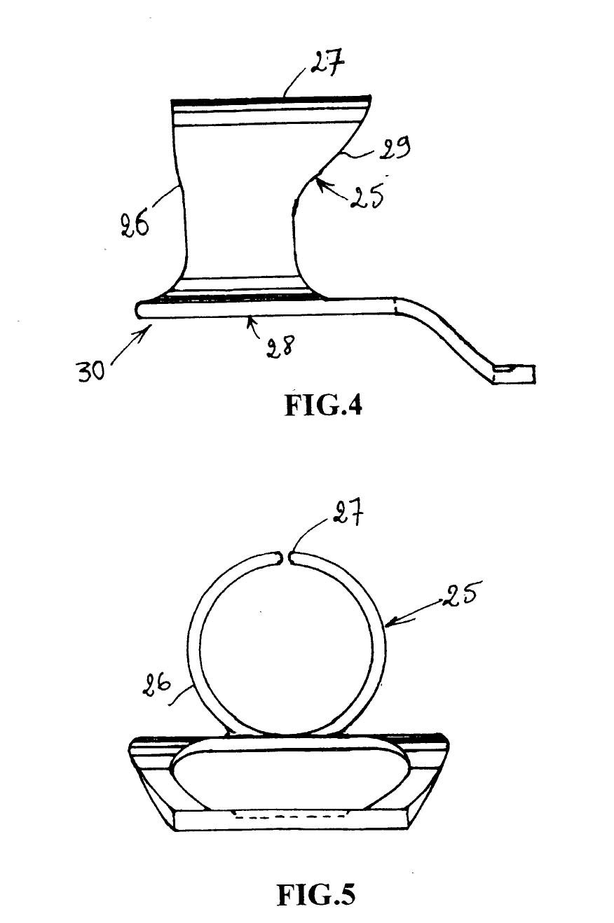

FIG. 4 is a view in elevation of an alternative form of embodiment of the bottle opener.

FIG. 5 is a side view thereof.

According to the invention, the device 1 (FIGS. 1 to 3) for fixing the bottle opener 2 is placed not at the level of the opening head 3 but at the level of the handle 4 so that the opening head 3 is placed in the palm of the hand while the handle 4 which is shortened and its fixing device 1 are at the level of the first finger bones, of the index and the middle finger, where they are differentiated; when the fingers are in place in the fixing device 1, the opening head 3 is placed in the palm of the hand; the opening head 3 is placed at the base of the first finger bones where these are no longer differentiated and are articulated to the metacarpal bones; in other words, between the base of the index finger and of the middle finger and the transverse crease of the palm. Under these conditions, the palm of the hand can be folded and the opening head 3 can retract into this region of the palm of the hand which is fleshy and not hamper the movements of the hand.

In a preferred version of the invention, a first fixing device 1 may consist of two ring sectors 5 and 6 (FIG. 1) of variable width 8 (FIG. 2) placed back to back with a common part 7 in their central region placed between the outside of the index finger and the inside of the middle finger (in the anatomic meaning of the term) where these two fingers meet; the thickness 9 of this common part 7 is of the order of 1 to 2 millimeters so as to allow the index and middle finger to remain contiguous and its width 10 (FIG. 2) may range from 5 to 10 millimeters; the common part 7 is placed and shaped in such a way that it can be housed and wedged where the two fingers meet, so that the middle and index finger can be moved apart without the fixing device 1 escaping; the lower part 11 of the ring sectors 5 and 6 is connected to the handle 4 which has a width 12 (FIG. 3) wide enough for the front part of the first finger bone of the index and of the middle finger to be able to press there without, however, hampering the movements of the ring finger and of the thumb; the upper part 13 of the ring sectors 5 and 6 comprises a widened region 14 on the side facing toward the articulation of the finger bones with the metacarpal bone; correspondingly, the regions of connection 15 of the upper part 13 of the ring sectors 5 and 6 with their common part 7 have deformable regions 15 allowing the curvature of the ring sectors 5 and 6 to adapt to suit the fatness of the user's fingers.

The opening head 3 (FIG. 1) comprises a central cut-out 16 comprising a first side situated on the same side as the fingers, a second side situated facing the side of the crease line of the palm and lateral sides connecting the first and the second side; the first side consists of a device 17 whereby the opening head 3 can bear against the upper part of the crown cork; this bearing device 17 is rigid roughly flat and situated in the continuation of the handle 4 which constitutes a lever arm; it has a roughly straight bearing border 18 bordering the cut-out 16, of a length of the order of magnitude of a chord of a circle circumscribing the crinkle band situated at a distance, ranging from one quarter to one sixth of the length of the diameter, away from the centre of the crinkle band; when the bearing device 17 is in place prior to the bottle-opening operation, the bearing border 18 determines a line of pivoting of the lever arm consisting of the handle 4, positioned as described above with respect to the circle circumscribing the crinkle band; when the bearing device 17 is in place prior to bottle-opening, it is positioned in a plane which makes a small angle with the upper part of the crown cork. The second side comprises a catching device 19 (FIG. 3) which is a rigid blade, the central region of which is placed under the crinkles of the crinkle band when the bearing device 17 is in place on the top face of the crown cork as described above; this catching device 19 comprises a catching border 20 which is either straight or slightly concave and which lies in a plane parallel to the plane of the bearing device 17 and at a distance of the same order of magnitude as the height of the crown cork.

The first side and second side are connected by lateral sides 21 and 22 of which the parts bordering the cut-out 16 preferably constitute guides 23 and 24 allowing the bearing 18 and catching 20 borders to be positioned correctly; indeed, all that is required is for the handle 4 to be placed on the upper part of the crown cork with the common part 7 centered on the upper part of the crown cork and for the hand to be moved straight forward, bending the fingers to grip the neck of the bottle under the crown cork so that the bearing border 18 becomes positioned on the crown cork and the catching border 20 becomes positioned under the crinkle band; next, the first finger bones of the index and middle finger press against the handle 4 via their front face, while the rear face of the first finger bones bear against the widened region 14 of the upper part 13 of the ring sectors 5 and 6 and allow the crown cork to be deformed thus uncrimping it.

In an alternative form of the invention, the first fixing device 1 (FIG. 1) is replaced by a second fixing device 25 (FIGS. 4 and 5) of the bottle opener 30 consisting of a ring 26 split at its upper part 27 fixed on the handle 28 and into which the middle or index finger of the hand is slipped; this ring has the same type of widened region 29 as those described for the upper part 13 (FIG. 2) of the ring sectors.

The fixing devices thus described can be made entirely of metal such as stainless steel sheet 2 millimeters thick for example, which is pressed and spot-welded; in a preferred version, part of the handle 4, 28 and the opening head 3 are made of metal, while the fixing device 1, 25 is made of injection-molded plastic which is preferably overmolded onto the handle 4, 28, the geometric characteristics of which have been modified to allow overmolding.

1. A bottle opener (2, 30) for a crown cork comprising an upper phase and a crinkle crimping band, the bottle opener consisting of a handle (4, 28) associated with an opening head (3) comprising a central cut-out (16) bordered by a bearing device (17) a catching device (19) and two lateral sides (21, 22) and with a first or a second fixing device (1) or (25), characterized in that the first or the second device (1) or (25) for fixing on the first finger bone of the index and/or middle finger of the hand are fixed to the handle (4) or (28) and in that the bearing device (17) is placed between the handle (4) or (28) and the catching device (19).

2. The bottle opener as claimed in claim 1, characterized in that the first device (1) for fixing to the first finger bone of the middle and index finger consists of two ring sectors (5 and 6) placed back to back with a common part (7), a lower part (11) which is connected to the handle (4), an upper part (13) comprising a widened region (14) and a deformable region (15) situated where the upper part (13) meets their common part (7).

3. The bottle opener as claimed in claim 1, characterized in that the second device (25) for fixing to the first finger bone of the index or middle finger consists of a ring (26) which is split at its upper part (27) and has a widened region (29) at its upper part.

4. The bottle opener as claimed in claim 1, characterized in that the bearing device (17) is rigid roughly flat and situated in the continuation of the handle (4) having a roughly straight bearing border (18) of a length of the order of magnitude of a chord of a circle circumscribing the crinkle band situated at a distance, ranging from one quarter to one sixth of the length of the diameter, away from the center of the crinkle band.

5. The bottle opener as claimed in claim 4, characterized in that when the bearing device (17) is in place prior to bottle-opening, it is positioned in a plane which makes a small angle with the upper part of the crown cork.

6. The bottle opener as claimed in claim 4, characterized in that the catching device (19) is a rigid blade which comprises a catching border (20) which is either straight or slightly concave and which lies in a plane parallel to the plane of the bearing device (17) and at a distance of the same order of magnitude as the height of the crown cork.

7. The bottle opener as claimed in claims 4 to 6, characterized in that the borders of the lateral sides (21 and 26) bordering the cut-out (16) are guides (23 and 24) allowing the bearing (18) and catching (20) borders to be positioned correctly.

8. A bottle-opening method using the opener as claimed in the preceding claims, whereby the handle (4) has to be placed on the upper part of the crown cork with the common part (7) centered on the upper part of the crown cork and the hand has to be moved straight forward, bending the fingers to grip the neck of the bottle under the crown cork so that the catching border (20) becomes positioned under the crinkle band, the first finger bones of the index and middle finger pressing against the handle (4) via their front face, while their rear face of the first finger bones bear against the widened region (14) and allow the crown cork to be deformed thus uncrimping it.

9. The bottle opener as claimed in claims 1, 2 or 3, characterized in that the first or second fixing devices (1) or (2) are made entirely of steel sheet which is pressed and spot-welded.

10. The bottle opener as claimed in claims 1, 2 or 3, characterized in that part of the handle (4) or (28) and the opening head (3) are made of metal, while the first or second fixing device (1) or (25) is made of injection-molded plastic which is overmolded onto the handle (4) or (28), the geometric characteristics of which have been modified to allow overmolding.
